(19) United States
(12) Patent Application Publication
(10) Pub. No.: US 2014/0210188 A1
(43) Pub. Date: Jul. 31, 2014

(54) COLLAPSIBLE DOLLY ASSEMBLY

(71) Applicants: Luca Buttazzoni, Miami, FL (US); Andres Bernal, Sunny Isles, FL (US)

(72) Inventors: Luca Buttazzoni, Miami, FL (US); Andres Bernal, Sunny Isles, FL (US)

(21) Appl. No.: 13/755,600

(22) Filed: Jan. 31, 2013

(51) Int. Cl. B62B 3/02

(52) U.S. Cl. CPC B62B 3/02
USPC 280/651

(57) ABSTRACT

A dolly assembly disposable between operative and collapsed orientations including a plurality of elongated links defining a plurality of link pairs. First and second joint members interconnect the plurality of link pairs, wherein correspondingly positioned first and second joint members of a common link pair are concurrently connected to at least one adjacent link pair. The first and second joint members of each link pair are disposed in confronting, weight supporting relation to one another and comprise the operative orientation. The collapsed orientation comprises the plurality of links of each of the plurality of link pairs disposable into a common, substantially longitudinal alignment or array with one another.

### BACKGROUND OF THE INVENTION

1. Field of the Invention

This invention relates to a dolly assembly structured to be selectively disposed between an operative orientation, for movable support of a variety of different objects and a collapsed orientation, facilitating the storage and transport of the dolly assembly by reducing the size and configuration thereof. Corresponding ones of a plurality of elongated links are movably connected to form a plurality of link pairs. First and second joint members are connected to each link of each of link pair and a plurality of such joint members pivotally interconnect adjacent link pairs and are structured to facilitate selective disposition of the dolly assembly into either the operative or collapsed orientation.

2. Description of the Related Art

The use of dolly structures is quite common for different applications in a variety of different industries. As such, dolly structures may be at least generally categorized as platform dollies, hand trucks, mobile carts, etc. In each instance the structural and operative features of the different dolly constructions are intended for use in movably supporting different objects over various surfaces, wherein the objects being movably supported may vary in weight, size, configuration, etc. Therefore, the manufacture and/or structural components of a dolly are typically dependent on the physical characteristics of the device with which the dolly is intended to be used.

By way of example, platform dollies usually have a relatively large platform supported by at least one or a plurality of wheels, rollers, castors, etc., which are fixedly secured to the under portion of the platform. In contrast, hand trucks normally comprise an elongated upper portion attached to an elongated lower portion having an outwardly extending support platform. As with platform type dollies, the hand truck usually includes fixedly or permanently attached wheels connected generally at the junction of the upper and lower portions. Somewhat similarly, movable, weight supporting carts may also be considered a dolly type construction. As such, weight supporting carts normally include a supporting base and a retaining structure associated therewith in a manner which facilitates the movable support of different objects. Similar to most category of dolly construction, the cart type dollies normally include fixedly attached wheels, rollers, etc.

In each of the above noted categories the dolly structure generally is of a fixed size and/or configuration and is not typically structured to be reduced in size, such as by being collapsed or at least partially disposed into a folded, reduced size configuration, which would facilitate storage, transportation and overall handling thereof when the dolly structure is not being used.

Therefore, problems and disadvantages associated with known or conventional dolly structures typically include their inability to be disposed into a collapsed or reduced size orientation when not in use. It is generally acknowledged that prior art dolly structures may be configured to movably support a variety of different objects. However, a prominent consideration in the design and structuring of conventional dollies is the weight, size and shape of the objects being supported. In turn, such considerations will most probably affect the size, configuration and overall weight bearing abilities of the dolly being used. By way of example, large platform dollies are generally intended to accommodate larger and/or relatively heavy devices which may also have a bulky shape or configuration. Accordingly, dollies of this type are not easily collapsed or reduced in size to facilitate the aforementioned storage or transport when not in use.

In turn, lighter weight or smaller dolly structures including, but not limited to, cart type dollies and hand trucks may be structured to movably support smaller relatively lighter loads than the aforementioned platform dollies. As a result these type of dollies may include at least some adjustable features or components in order to facilitate the handling thereof. However, such adjustable features may be only minimally operative to significantly reduce the size and configuration of this category of dollies. As a result, dollies of this type are not normally structured to be disposed in a sufficiently collapsed orientation, of sufficiently reduced size and configuration, to permit their efficient and effective storage, transport, etc., either individually of collectively.

Therefore, there is a need in the area associated with the design and manufacture of dollies for a dolly assembly structured to be easily, quickly and reliably disposed between an operative, weight supporting orientation and a collapsed orientation. Moreover, when in the preferred operative orientation, the improved dolly assembly should preferably be disposed in a substantially low lying, generally flattened, horizontal orientation, close to a supporting surface. In contrast, when in a collapsed orientation, such an improved dolly assembly should be significantly reduced in size and configuration so as to facilitate storage, transportation and handling thereof, when not in use.

Such a proposed and improved dolly assembly should also have a plurality of cooperatively designed components, at least some of which may be structured into mirror images of one another, thereby facilitating their manufacture and assembly into a dolly assembly of a variable and preferred size and configuration. The versatility of such an improved and proposed dolly assembly thereby enables it to be structurally modified into an intended, predetermined configuration so as to efficiently and safely accommodate the movable support of one or more, different objects, which may differ in size, weight, shape, etc.

Therefore, the structural and operative features of a preferred dolly structure will be such as to overcome the disadvantages and problems long recognized in the use of conventional or known dolly structures of the type generally described above.

### SUMMARY OF THE INVENTION

The present invention is directed to a dolly assembly structured to be selectively disposed between an operative, weight supporting or weight bearing orientation and a collapsed orientation. In the collapsed orientation, the size and configuration of the dolly assembly are significantly reduced. As such, the collapsed orientation of the dolly assembly facilitates its storage, handling, transportation, etc. when not in use. In addition, the versatility of the various preferred embodiments of the dolly assembly facilitate it being structured to assume a variety of different sizes and/or configurations, so as to effectively accommodate the movable support of various objects, which may differ in size, configuration, weight, etc.

Accordingly, the dolly assembly of the present invention includes at least one main or primary dolly section comprising a plurality of elongated links, wherein corresponding ones of the links are disposed and interconnected into a plurality of link pairs. A plurality of joint members are structured and disposed to accomplish an intended movable interconnection of adjacent ones of the link pairs to form the main or first dolly section. Other preferred embodiments of the dolly assembly comprise the plurality of joint members being disposed and structured to facilitate the connection of one or more supplementary dolly sections to the main dolly section and to one another additional. In more specific terms, the plurality of joint members comprise a plurality of first joint members and a plurality of second joint members having common structural and operative features. Further, the first and second joint members are cooperatively structured and disposed to movably interconnect the plurality of link pairs defining the main dolly section and/or any one of a possible plurality of supplementary dolly sections connected thereto, as set forth above.

Further, each link of each link pair comprises opposite ends movably connected to a different one of the first and second joint members. Moreover, corresponding links are movably connected to one another, preferably by an “X-type” or “scissor-type” pivotal connection disposed intermediate the opposite ends of the corresponding links of a common link pair. Moreover, correspondingly disposed first and second joint members of different links, of the same link pair, may be concurrently connected to at least one adjacent link pair to form either the main dolly section or part of one or more supplementary dolly sections, which may be connected to the main dolly section and/or to one another.

Additional structural and operative features of the various preferred embodiments of the dolly assembly facilitate it being selectively disposed into the aforementioned operative orientation. As such correspondingly positioned first and second joint members of different links, of a common link pair, are disposed in confronting, weight transferring or weight supporting relation to one another. As such, the operative orientation facilitates the safe and reliable movable support of a variety of different objects, having the weight thereof transferred to the plurality of first joint members. In turn, the weight of the supported device will be shared and/or transferred in part from the first joint members to correspondingly disposed ones of the second joint members. Therefore, the correspondingly positioned ones of the first and second joint members may be accurately described as being disposed in weight supporting or weight bearing relation to one another.

As also set forth above, the versatility of the various dolly assembly embodiments is further demonstrated by the selective disposition thereof into the aforementioned collapsed orientation. Accordingly, the collapsed orientation of one or more preferred embodiments of the present invention may be accurately described by the plurality of links of each interconnected link pair being disposed into a common, substantially longitudinal alignment with one another. As a result, the substantially longitudinal alignment of the corresponding links, of each link pair are thereby disposed in or collectively comprise a longitudinally aligned array of such links and link pairs. Moreover, when in the substantially longitudinal alignment or longitudinally aligned array, the first and second joint members of each link of each link pair are disposed in longitudinally spaced relation to one another, generally at opposite ends of the longitudinally aligned array of links. This of course is in contrast to the operative orientation, wherein the plurality of movably interconnected link pairs may be disposed in a substantially low lying, generally flattened, horizontal orientation, close to a supporting surface. As indicated above, the low lying configuration of the dolly assembly, when in an operative orientation, is due in part to the correspondingly disposed first and second joint members of a common link pair being disposed in confronting, weight transferring or weight supporting relation to one another.

Yet another feature of the present invention is the structural and operative features which are associated with the movable or pivotal interconnection of correspondingly disposed links of a common link pair. At least a predetermined number of link pairs defining the dolly assembly include two of the plurality of links being movably connected to one another, intermediate their opposite ends. Preferably this movable connection comprises an “X-type” or “scissor-type” pivotal connection located substantially midway between the opposite ends of the corresponding links of the formed link pair. As a result, the operative orientation of a dolly assembly may be substantially “flattened” or low-lying, as set forth above, thereby facilitating the positioning of an object to be supported, thereon. Moreover, the operative versatility of the “X-type” or “scissor-type” pivotal connection also facilitates the selective positioning of the interconnected links and link pairs of the dolly assembly into the collapsed orientation comprising the aforementioned substantially longitudinally aligned array, as set forth above.

However, at least one additional preferred embodiment of the dolly assembly include a predetermined number of link pairs demonstrating the “x-type” or “scissor-type” pivotal connection, wherein additional link pairs of the dolly assembly may not include the “x-type” or “scissor-type” pivotal connection. In light of the above, it is preferred that the “X-type” or “scissor-type” pivotal connections between two links defining a common link pair be used on a predetermined number of link pairs of the same dolly assembly section in order to maintain stability and intended operation during use. This will assure that the corresponding dolly assembly including the main and/or supplementary dolly section thereof will demonstrate an intended and desired stability needed to reliably and safely movably support one or more objects thereon.

The various embodiments of the dolly assembly of the present invention include the use of a mobile support assembly connected to predetermined portions of the dolly assembly so as to provide for the movement thereof, when in its operative orientation. More specifically, in at least one preferred embodiment, the mobile support assembly comprises a plurality of castors. In at least one embodiment, each of the castors is connected to a different predetermined joint member mounted on opposite ends of each link pair. In order to assure that the weight bearing capabilities are adequate for a given dolly assembly, each castor assembly preferably comprises an in-line castor. One example of an in-line castor construction specifically includes, but is not limited to, a ball castor or ball roller type castor. In such in-line castors, the longitudinal axes of the connecting link associated with the castor is substantially coincident with the center of the ball type roller defining the ball castor. It has been found that in certain applications, the in-line and/or ball castor provides greater strength and stability, especially when considering the movable support of relatively heavy objects or devices and/or those that include bulky or somewhat nonsymmetrical configurations.

The versatility of the dolly assembly of the present invention is further demonstrated by the provision of each of the first and second joint members being structured to be essentially mirror images of one another. Therefore, as practically applied, correspondingly disposed first and second joint members located at opposite ends of a common link pair may be reversely oriented. As such, the first joint member will be disposed above or “on top of” the lower or second joint member, when the dolly assembly is in the operative orientation. Therefore, the plurality of in-line castors defining the mobile support assembly will each be connected to the lower one or second joint member of the correspondingly positioned first and second joint members located at the same end of a common link pair. However, due to the “mirror image” construction, during assembly or construction, either one of the plurality of joint members may be used as the first or second joint member, wherein the castor is always connected to the lower one or “second” joint member. Moreover, the manufacture of each of the first and second joint members is facilitated and any problems or disadvantages associated with the structural design of the first and second joint members differing from one another may be eliminated or significantly reduced.

Further structural and operative features associated with each of the joint members comprise their being structured to include a base having a plurality of connecting portions formed thereon. Each connecting portion faces outwardly in a different direction from the remainder of the base. Further, each of the connecting portions of a common base is disposed in receiving relation to an opposite end of one link of a different link pair. Moreover, each of the connecting portions include an open ended channel and a pivotal member disposed within the channel which facilitates the pivotal connection of the corresponding end of each link to the base of each joint member. Therefore, the base and the aforementioned connecting portions associated therewith are cooperatively structured with the plurality of links to which they are attached to facilitate the quick, easy and reliable disposition of each of the links and link pairs between the operative orientation and the substantially longitudinally aligned array of the links, comprising the collapsed orientation.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side view of one preferred embodiment of the dolly assembly of the present invention in an operative orientation.

FIG. 2 is a top view of the embodiment of FIG. 1.

FIG. 3 is an exploded, perspective view of the embodiment of the dolly assembly as represented in FIGS. 1 and 2, in an unassembled form.

FIG. 4 is an exploded, perspective view in partial cutaway showing structural details of various components of the embodiment of FIGS. 1 and 3.

FIG. 4A is a side view in schematic form of the structural details of each of a plurality of joint members serving to interconnect adjacent link pairs of the various preferred embodiments of the dolly assembly of the present invention.

FIG. 5 is a perspective detail view in partial cutaway of an “X-type” or “scissor-type’ pivotal connection between corresponding links of a common link pair associated with the embodiments of FIGS. 1 through 4.

FIG. 6 is yet another preferred embodiment of the dolly assembly of the present invention which at least partially incorporates the “X” or “scissor-type” pivotal connection represented in the embodiment of FIG. 5, in one or more, but not all of the link pairs of the dolly assembly.

FIG. 7A is a front view of the one or more preferred embodiments of the present invention in a collapsed orientation.

FIG. 7B is a side view of the embodiment of FIG. 7A.

FIG. 7C is a bottom view of FIGS. 7A and 7B.

FIG. 8 is a schematic representation of yet another preferred embodiment of the present invention comprising a plurality of supplementary dolly sections connected to and operatively associated with a primary dolly section of the type represented in FIGS. 1-4.

FIG. 9 is composite view in schematic form representing some, but not all, of a plurality of possible configurations that the dolly assembly of the embodiment of FIG. 8 may assume.

Like reference numerals refer to like parts throughout the several views of the drawings.

### DETAILED DESCRIPTION OF THE PREFERRED EMBODIMENT

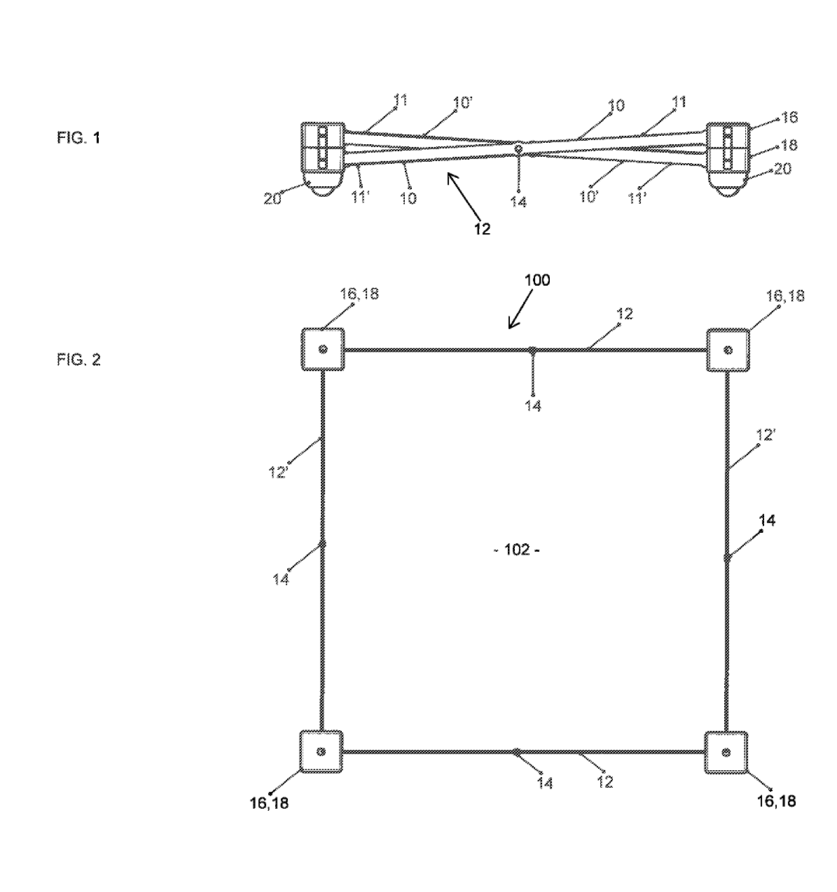

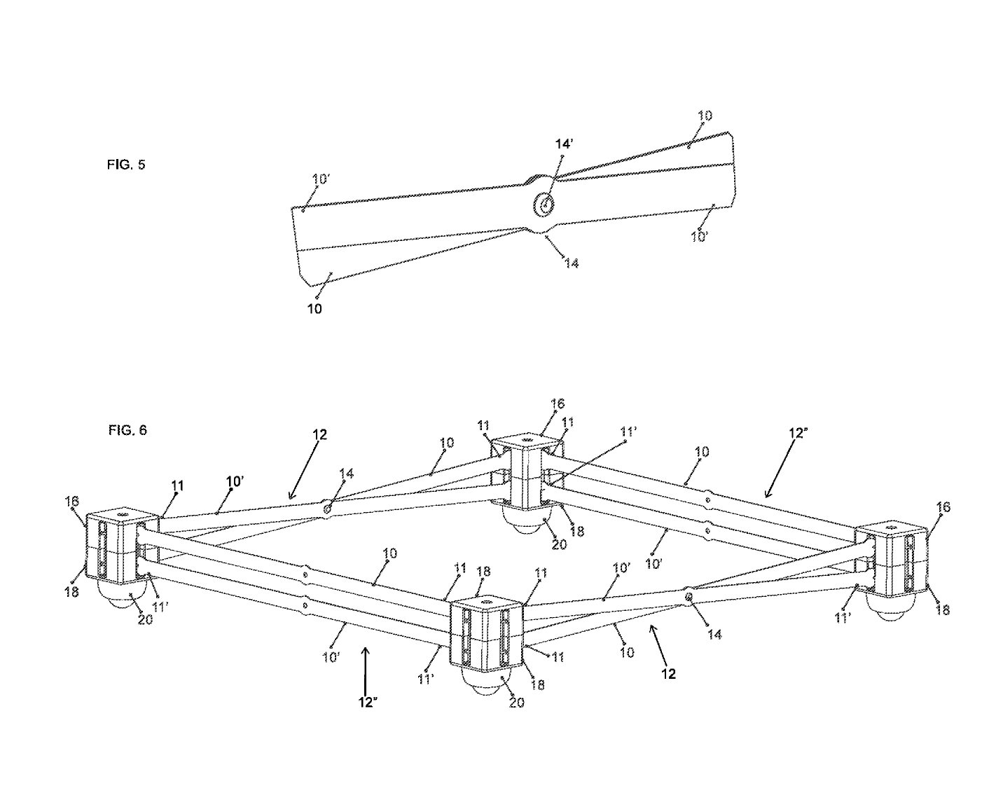

As represented in the accompanying drawings, the present invention is directed to a dolly assembly, generally indicated as 100, which is structured to be selectively disposed into an operative orientation, as represented in FIGS. 1 and 2, for movable support of a variety of different objects. The dolly assembly 100 is also structured to be easily and quickly disposed, without detachment or disconnection of any of its components, into a collapsed orientation, as represented in FIG. 5. The collapsed orientation facilitates the storage and transport of the dolly assembly by reducing the size and configuration of the dolly assembly 100.

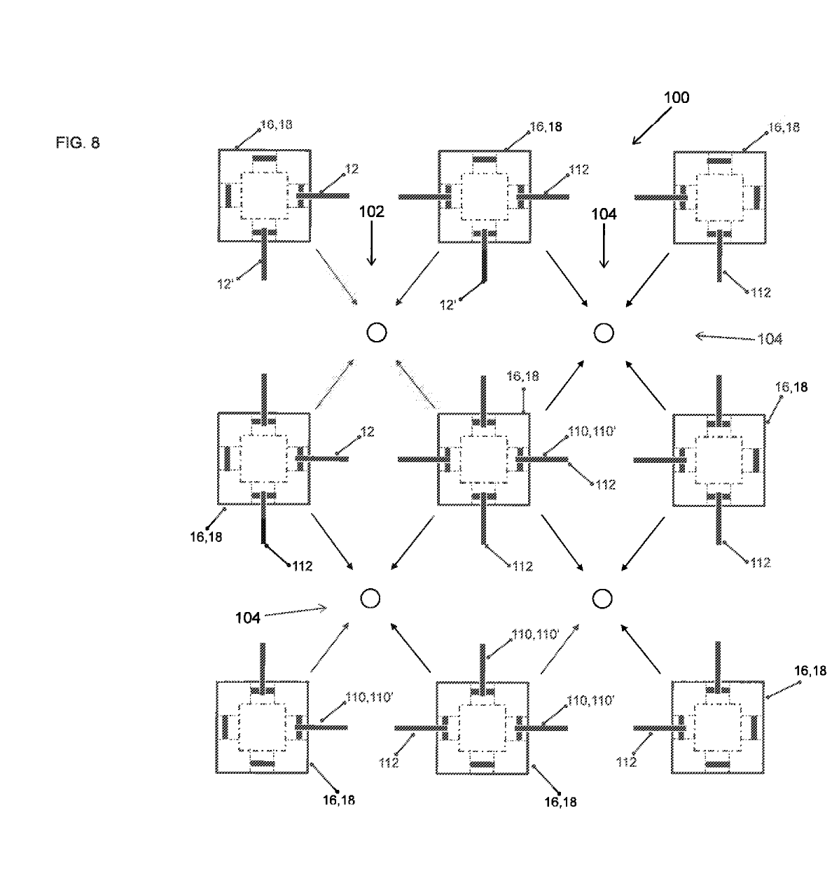

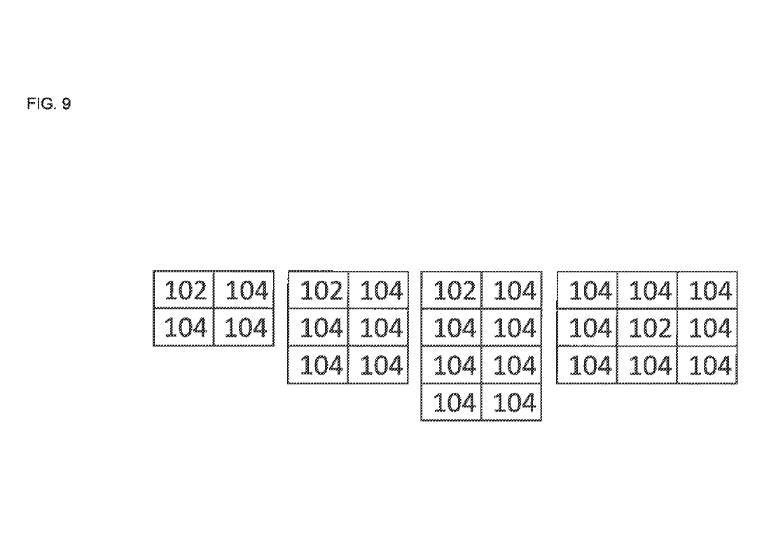

In addition, the dolly assembly 100 may comprise a first or main dolly section 102 or, as explained in greater detail hereinafter, the dolly assembly 100 may comprise an additional number of “supplementary” dolly sections 104. Accordingly, one feature of the dolly assembly 100 is the ability thereof to be easily and quickly modified to assume a variety of different sizes and/or configurations, in order to accommodate the movable support of a variety of objects which may differ in size shape, configuration, etc. For purposes of clarity, the various structural and operative features of the present invention will be at least initially described with primary reference to the dolly assembly 100 having a first of main dolly section 102. However, it is emphasized that the one or more additional “supplementary” dolly sections 104, as schematically represented in FIGS. 8 and 9, have substantially equivalent structural and operative features as the embodiment of FIGS. 1-4, as set forth in detail herein.

Accordingly the dolly assembly 100, including the first or main dolly section 102, comprises a plurality of elongated links 10, wherein corresponding ones of the links 10 are disposed and/or movably connected into a plurality of cooperatively disposed link pairs, generally indicated as 12. For purposes of clarity corresponding links of a common link pair 12 are designated 10 and 10′. As also represented throughout the Figures, a movable connection of the corresponding links 10 and 10′ is preferably defined by an “X-type” or “scissor-type” pivotal connection, generally indicated as 14 and represented in detail in FIG. 5.

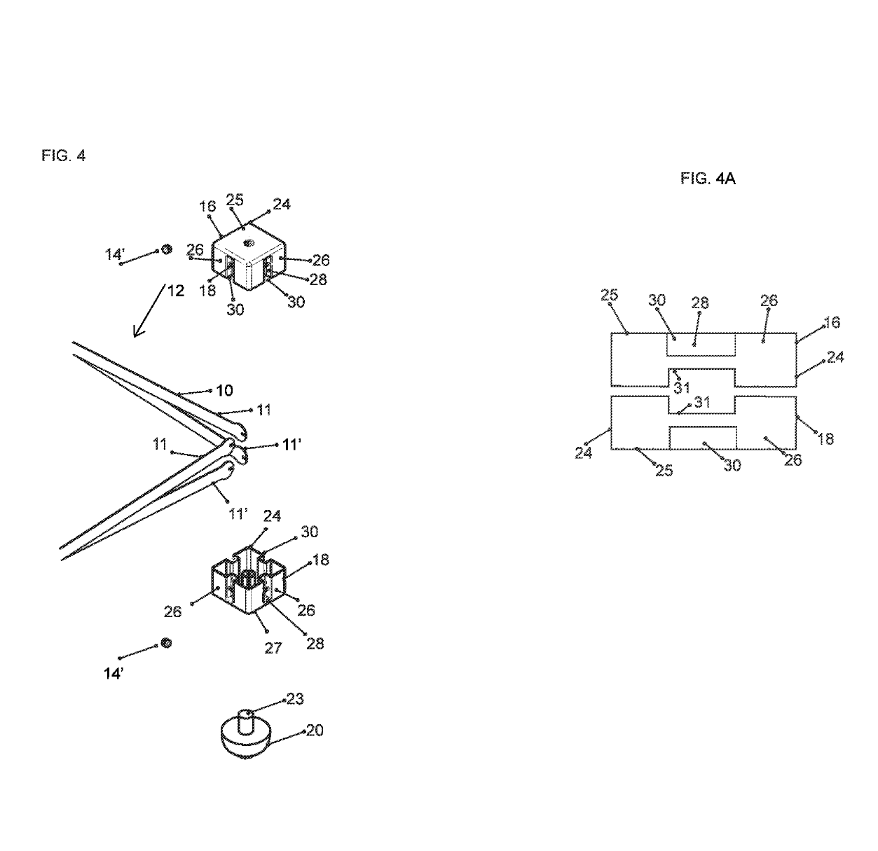

With certain exceptions relating to structural modifications represented in the additional preferred embodiment of FIG. 6, preferably all of the plurality of link pairs 12, defining at least a main dolly section 102 include the “X-type” and/or “scissor-type” pivotal connection 14. In more specific terms and as represented in detail in FIG. 4, each of the “X-type” or “scissor-type” pivotal connections include a pivot pin 14′ or like member pivotally interconnecting corresponding links 10 and 10′, of a common link pair 12, at a location substantially midway or at least intermediate the opposite ends of each of the corresponding links 10 and 10′. The use of the described “X-type” or “scissor-type” pivotal connection provides stability and facilitates the positioning of the dolly assembly 100 and one or more dolly sections 102 and 104 into a substantially low lying, horizontal position, relatively close to a supporting surface 105 over which dolly assembly 100 may travel while supporting the weight of a variety of different objects thereon.

The dolly assembly 100 of the present invention, including the first or main dolly section 102, also includes a plurality of joint members preferably including a plurality of first joint members 16 and a plurality of second joint members 18. As described in greater detail hereinafter with specific reference to FIGS. 1-4 and 4A, at least one embodiment of the present invention comprises the first and second joint members 16 and 18 being structured to effectively define “mirror images” of one another, thereby rendering their manufacture or formation more efficient. As assembled, each of the corresponding links 10 and 10′ include opposite ends 11 and 11′ pivotally connected to different ones of the first and second joint members 16 and 18 respectively. As represented, each of the opposite ends 11 of each link 10 and 10′ is pivotally connected to a first of the joint members 16. In turn, each of the opposite ends 11′ of each link 10 and 10′ is pivotally connected to a second one of the joint members 18. As also represented, each of the first and second joint members 16 and 18 are structured to be concurrently and pivotally connected to corresponding links 10 or 10′ of at least two adjacent link pairs, as at 12 and 12′ represented in FIGS. 1, 3 and 4.

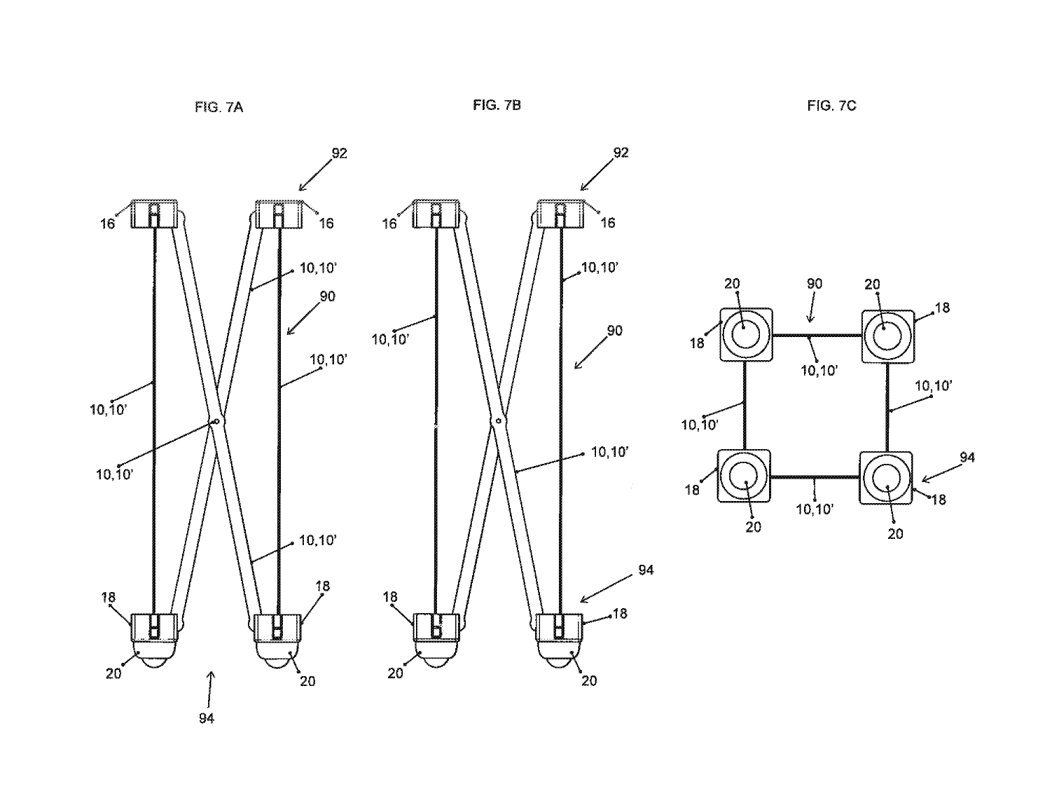

Also, each of the first links 16 is connected to the correspondingly disposed opposite ends 11 of corresponding links 10 and 10′ of the different link pairs 12 and 12′. In cooperation therewith, each of the second joint members 18 may be pivotally connected to corresponding opposite ends 11′ of the links 10 and 10′ of at least two of the adjacent and different link pairs 12 and 12′. Therefore, as more fully explained herein, each of the correspondingly disposed first and second joint members 16 and 18 serve to concurrently and cooperatively, pivotally connect at least two adjacent link pairs 12 and 12′ in a manner which facilitates the selective positioning of the dolly assembly 100 and first dolly section 102 in the operative orientation of FIGS. 1 and 2 or in the collapsed orientation, as generally represented in FIG. 7A-7C.

With further regard to FIG. 7A-7C, the collapsed orientation of the embodiments of FIGS. 1-5 is schematically represented and comprises the plurality of links 10 and 10′ of each of said link pairs 12 and 12′ being substantially longitudinally aligned and/or being disposed into a common, substantially longitudinally aligned array 90. The longitudinally aligned array 90 further comprises the first and second joint members 16 and 18 respectively, of each link pair 12 and 12′ being disposed in spaced relation to one another, and located at substantially opposite ends 92 and 94 of said longitudinally aligned array 90.

Moreover, the operative orientation of the dolly assembly and the one or more dolly sections 102, 104, etc. may be specifically described by each of the correspondingly positioned first and second joint members 16 and 18, of each link pair 12 or 12′, being disposed in confronting, weight transferring or weight bearing relation to one another. Such a confronting, weight transferring relation of the first joint member 16 relative to the correspondingly positioned second joint member 18 is facilitated by the aforementioned “x-type” or “scissor-type” pivotal connection 14. Therefore, when one or more objects are mounted on the plurality of first joint members 16 of the dolly assembly 100, while in the operative orientation of FIG. 1, the weight thereof is directed at least initially, but not exclusively, to the plurality of “upper” first joint members 16. Due to the confronting, weight transferring relation of the first joint members 16 relative to the second joint members 18, the weight of the supported object will in turn be at least partially transferred or shared with the correspondingly positioned “lower” second joint member 18 as well as the plurality of castors 20 connected to the second joint members 18.

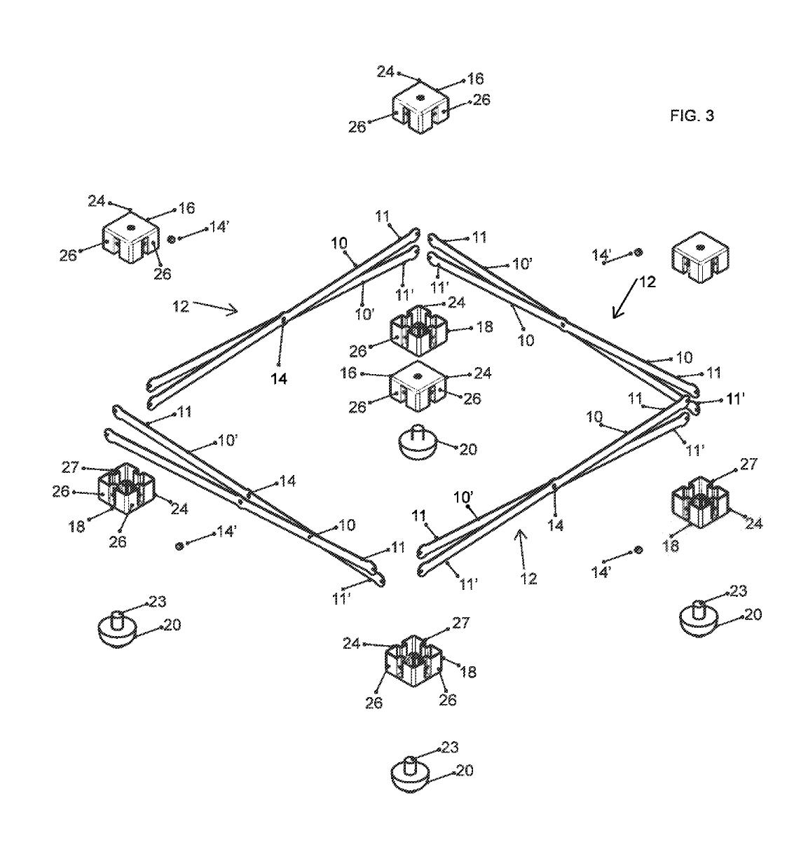

With primary reference to FIGS. 3 and 4 and as set forth above, the versatility of the dolly assembly 100 is significantly enhanced due to the fact that the first and second joint members 16 and 18 may be structured to be essentially “mirror images” of one another. Therefore, during assembly and prior to the fixed or removable connection of the castors 20 to the second joint member 18, any base 24, at least partially defining each of the joint members 16 and 18 can be used as either the first or second joint member 16 or 18 respectively, due to the mirror image structuring of the base 24. As such, the first joint member 16 will be disposed upwardly or “on top of” the lower or second joint member 18 when the dolly assembly 100 is in the operative orientation. Therefore, as indicated, each of the plurality of castors 20, defining the mobile support for the dolly assembly 100 and each of the one or more dolly sections 102, 104, etc., will be connected to the lower or second joint member 18 of the correspondingly positioned first and second joint members 16 and 18.

With further regard to FIGS. 3, 4 and 4A, each of the first and second joint members 16 and 18 include the base, generally indicated as 24, having an outer end or platform structure 25. Each of the bases 24 also include a plurality of connecting portions, generally indicated as 26, which may at least partially define an outer side or wall segment of each base 24. Moreover, each of the connecting portions 26 face outwardly in a substantially different direction from the remainder of the base 24. As represented, each or one or more of the bases 24 and the corresponding connecting portions 26 may have a multisided configuration. As such, the number and relative disposition of the connecting portions 26 and/or sides of the base 24 may vary to further enhance the versatility of each of the plurality of joint members 16 and 18.

Also, each of the connecting portions 26 is disposed in receiving relation to an opposite end 11 or 11′ of different links 10 or 10′ of a link pair 12, 12′ and 12″ (FIG. 6). A pivotal connection of the ends 11 and 11′ with the base 24 is preferably accomplished by each of the connecting portions 26 including a channel 28 formed therein. Further, each of the channels 28 includes an open end 30 and a pivot member 31. The pivot member 31 is structured to facilitate pivotal connection of a correspondingly disposed extremity of an opposite end 11 or 11′ of corresponding links 10 or 10′ to the base 24 of each first and second joint member 16 or 18. Moreover, when the plurality of links pass from the operative orientation of FIG. 1, into the collapsed orientation of FIG. 7, each of the opposite ends 11 and 11′ which are, pivotally connected to one of the first and second joint members 16 and 18, will pass through the open end 30. The provision of the open ends 30 thereby prevents any interference of the base 24 with the intended travel of the ends 11 and 11′ and or the respective links 10 and 10′, as they move into the collapsed orientation. Therefore, the base 24 and the aforementioned connecting portions 26 are cooperatively structured with the plurality of links 10 and 10′, to which they are pivotally connected, to facilitate the quick, easy and reliable disposition of each of the links 10 and 10′ and link pairs 12 and 12′ between the operative orientation and the collapsed orientation.

Further with regard to FIGS. 3 and 4, each of the plurality of castors 20 preferably comprise in-line castors specifically including, but not limited to, ball castors or ball type rollers. As such, each of the in-line castors 20 include a connecting finger or linkage 23 cooperatively structured to be securely and either fixedly or removably attached to a mountings structure 27 disposed on and at least partially within each of the bases 24. Due to the aforementioned “mirror” construction of each of the bases 24, the mounting structure 27 will be considered an integrated part of each of the bases 24. As a result and as set forth above, during assembly and/or construction, each of the bases 24 can be attached to the castor 20 and thereby serve as the second joint member 18, as previously described.

Yet another preferred embodiment is schematically represented, in FIGS. 5 and 6 and generally indicated as 100′. More specifically, the dolly assembly 100′ and/or a primary or main section thereof comprises a predetermined number of at least one, but preferably at least two link pairs 12 and 12′, having the respective links 10 and 10′ movably interconnected utilizing the aforementioned “x-type” or “scissor-type” pivotal connection 14. However, one or more additional link pairs as at 12″ may be absent the “x-type” or “scissor-type” pivotal connection 14. Instead the one or more link pairs 12″ include each link 10 and 10′ thereof comprising a substantially straight line orientation, absent any inter connecting pivotal or other type connection there between. Accordingly, the opposite ends of each of the links 10 of the link pairs 12″ is pivotally connected to a first joint member 16. The other link 10′, of the same link pair 12″, has each of its opposite ends pivotally connected to a second joint member 18. This of course differs from each of the link pairs 12 and/or 12′, wherein each link 10 and 10′ thereof has its opposite ends movably or pivotally connected to a different one of said first and second joint members 16 and 18 respectively.

Further with regard to the embodiment of FIG. 6, the provision of the pivotal connection 14 connecting opposite one of the link pairs 12 will still result in the selective positioning of the dolly assembly 100′ in either the operative orientation as represented in FIG. 6 or the collapsed orientation comprising a modified longitudinal array similar to but differing from the longitudinally aligned array as represented in FIGS. 7A, 7B and 7C. More specifically, the collapsed orientation of FIG. 6 comprises the opposite link pairs 12′ pivoting about the connection 14 such that all the first joint members 16 will be collectively disposed at one end of the collapsed longitudinal array, while all the second joint members 18 will be disposed at the opposite end of the collapsed longitudinal array.

In that the links 10 and 10′ of each of the link pairs 12″ are not pivotally connected to one another, the collapsed array of the embodiment of FIG. 6 will comprise the links 10 of each link pair 12″ being disposed at one end of the collapsed longitudinal array associated with the location of the first joint members 16. In contrast, the links 10′ of each link pair 12″ will be oppositely disposed, at the end of the collapsed longitudinal array associated with the location of the second joint members 18. As a result, when the dolly assembly 100′ is in the collapsed orientation, all the first joint members 16 will be located at the same end of the collapsed longitudinal array and all of the second joint members 18 will be located at the opposite end of the collapsed longitudinal array.

However, the collapsed longitudinal array of the dolly assembly 100′ of FIG. 6 will further comprise the first joint members 16 connected to the links 10 of each link pair 12″ being spaced from one another by a distance substantially equal to the length of the unconnected link 10 of each link pair 12″, while being concurrently located at the same end of all of the rest of the first joint members 16. Similarly, the collapsed longitudinal array of the dolly assembly 100′ will further comprise the second joint members 18 connected to the links 10′ of each link pair 12″ being spaced from one another by a distance substantially equal to the length of the unconnected link 10′ of each link pair 12″, while being concurrently located at the same end of all of the rest of the second joint members 18. Also, the inclusion of preferably a plurality of at least two “x-type” or “scissor-type” pivotal connections 14 on appropriate ones of link pairs 12 will serve to provide containment of all of the components of the dolly assembly 100 of FIG. 6 in working relation to one another, in both the operative and collapsed orientations.

As set forth above, the dolly assembly 100 of the present invention includes at least a first or main dolly section, as represented in FIGS. 1 and 2. However, due to the structural and operational versatility of each base 24, of each of the first and second joint members 16 and 18, a plurality of auxiliary links 110, 110′ may be connected to correspondingly disposed, first and second joint members 16 and 18 of the first or main dolly section 102, as represented in FIG. 8. As such, corresponding ones of the plurality of auxiliary links 110, 110′ define a plurality of auxiliary link pairs 112 similar in structure, configuration and operation to the link pairs 12 or 12′ in FIGS. 1 through 4. Accordingly, at least some of the auxiliary link pairs 112 extend outwardly from and are pivotally connected to different, correspondingly positioned ones of the first and second joint members 16 and 18 of a link pair 12 or 12′ of the main dolly section 102 of the dolly assembly 100. In addition, at least some others of the auxiliary links 110′ and corresponding link pairs 112′ are directly connected to one another, rather than the first or main dolly section 102. In providing such additional connections, a plurality of supplementary dolly sections 104 may be formed on and/or added to the dolly section 102 and to others of the supplementary dolly sections 104.

Therefore, as schematically represented in FIG. 9, the size and configuration of the dolly assembly 100 may be significantly varied by combining a plurality of supplementary dolly sections 104 in an appropriate relation to one another. Different sizes and configurations of the dolly assembly 100 can thereby be easily and efficiently accomplished in order to accommodate the movable support of a variety of objects or devices, which may differ in size, shape, weight, etc. It is emphasized the various configuration of combined dolly sections 102 and 104 as represented in FIG. 9 are representative only of a number of other possible combinations, wherein the actual size and configuration of the dolly assembly used is based, at least in part, on the size, shape, weight, etc. of the object(s) intended to be movably supported.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A dolly assembly structured for disposition between an operative orientation and a collapsed orientation, said dolly assembly comprising:
a plurality of links disposed into a plurality of link pairs,
a plurality of joint members, corresponding links of each link pair including opposite ends pivotally connected to a different one of said plurality of joint members,
each of said plurality of joint members pivotally and concurrently connected to at least one link of each of at least two adjacent link pairs,
said links of at least one of said link pairs being pivotally connected to one another intermediate said opposite ends thereof,
said plurality of joint members comprising a plurality of first and second joint members; said first and second joint members of said links of a common one of said link pairs disposed in confronting, weight transferring relation to one another to at least partially define the operative orientation, and
said links of each of said link pairs disposable into a common, substantially longitudinally aligned array, said array at least partially defining the collapsed orientation.

2. A dolly assembly as recited in claim 1 further comprising said first and second joint members of each link pair being disposed in spaced relation to one another at substantially opposite ends of said longitudinally aligned array to further define the collapsed orientation.

3. A dolly assembly as recited in claim 1 further comprising said at least one link pair comprising said opposite ends of each of said links thereof connected to a different one of said first and second joint members.

4. A dolly assembly as recited in claim 1 wherein corresponding ones of said links of at least two of said plurality of link pairs are pivotally connected to one another intermediate said opposite ends thereof.

5. A dolly assembly as recited in claim 4 wherein said links of each of said plurality of link pairs are pivotally connected to one another intermediate said opposite ends thereof.

6. A dolly assembly as recited in claim 5 wherein said plurality of link pairs are collectively disposed into a closed peripheral configuration.

7. A dolly assembly as recited in claim 5 wherein each of said links of adjacent ones of said plurality of link pairs comprise correspondingly disposed opposite ends thereof pivotally connected to common first and second joint members.

8. A dolly assembly as recited in claim 1 wherein each of said plurality of joint members comprises a base including a plurality of connecting portions, each of said connecting portions facing outwardly in a different direction from said base in receiving relation to one opposite end of one of said links of a different link pair.

9. A dolly assembly as recited in claim 8 wherein each of said connecting portions include a channel having an open end, said channel dimensioned to receive a correspondingly disposed opposite end therethrough into pivotal connection with said base, said open end disposed to facilitate passage there through when said plurality of links are disposed in said longitudinally aligned array.

10. A dolly assembly as recited in claim 8 wherein said plurality of link pairs are collectively disposed into a closed peripheral configuration to further at least partially define the operative orientation.

11. A dolly assembly as recited in claim 10 further comprising a plurality of auxiliary link pairs; at least some of said auxiliary link pairs pivotally connected to different correspondingly positioned ones of said connecting portions of said bases of said first and second joint members of a common link pair of said closed configuration, said plurality of auxiliary link pairs extending outwardly from said closed configuration to at least partially define at least one supplementary dolly section.

12. A dolly assembly as recited in claim 1 further comprising a plurality of castors each connected to a different one of said plurality of joint members, said plurality of castors and corresponding ones of said plurality of joint members connected thereto disposable in movable engaging relation to a supporting surface, at least when said plurality of links and link pairs are in the operative orientation.

13. A dolly assembly as recited in claim 1 wherein each of said plurality of castors are connected to a different one of said second joint members; said operative orientation further comprising said first joint member disposed in engaging, weight transferring relation to correspondingly disposed ones of said second joint members and said castors connected thereto.

14. A dolly assembly structured for disposition between an operative orientation and a collapsed orientation, said dolly assembly comprising:
a plurality of elongated links; corresponding ones of said plurality of links disposed into a plurality of link pairs,
a plurality of first joint members and a plurality of second joint members; said first and second joint members collectively and movably interconnecting said plurality of link pairs,
each link of at least one of said link pairs having opposite ends movably connected to a different one of said first and second joint members,
correspondingly positioned first and second joint members of a common link pair being concurrently connected to at least one adjacent link pair,
said first and second joint members of said links of each link pair disposed in confronting, weight supporting relation to one another to at least partially define the operative orientation,
said plurality of links of each of said link pairs disposable into a common, substantially longitudinal alignment with one another to at least partially define the collapsed orientation, and
a mobile support assembly connected to said plurality of link pairs and disposable in movable engaging relation with a supporting surface, at least when said link pairs are in the operative orientation.

15. A dolly assembly as recited in claim 14 wherein said movable support assembly comprises a plurality of ball castors each connected to a different one of said plurality of second joint members.

16. A dolly assembly as recited in claim 14 wherein said links of each of at least two of said plurality of link pairs are connected to one another intermediate said opposite ends thereof to define a pivotal, scissor connection there between.

17. A dolly assembly as recited in claim 14 wherein each of said plurality of joint members comprises a base including a plurality of connecting portions, each connecting portion facing outwardly in a different direction from said base in receiving relation to at least one opposite end of one of said links of a corresponding one of said link pairs.

18. A dolly assembly as recited in claim 17 wherein each of said connecting portions include a channel having an open end, said channel dimensioned to receive a corresponding opposite end therethrough into pivotal connection with said base, said open end disposed to facilitate passage of said corresponding opposite end there through when said plurality of links and link pairs are disposed in said longitudinal alignment.

19. A dolly assembly as recited in claim 14 wherein said plurality of link pairs are collectively disposed into a substantially closed peripheral configuration to further at least partially define the operative orientation.

20. A dolly assembly as recited in claim 19 further comprising a plurality of auxiliary link pairs; at least some of said auxiliary link pairs pivotally connected to different, correspondingly positioned ones of first and second joint members of at least one of said link pairs of said closed peripheral configuration, said plurality of auxiliary link pairs extending outwardly from said closed configuration to at least partially define at least one supplementary dolly section.
